(19) United States
(12) Patent Application Publication
(10) Pub. No.: US 2023/0135380 A1
(43) Pub. Date: May 4, 2023

(54) INTELLIGENT SCHEDULING SERVICE

(71) Applicant: Microsoft Technology Licensing, LLC, Redmond, WA (US)

(72) Inventors: Apoorva KUMAR, Dublin (IE); Dinh Hajasambatra DOAN VAN BIEN, Dublin (IE); Abhishek DUBEY, Dublin (IE); Leanne CARROLL, Dublin (IE); Farhaz KARMALI, Seattle, WA (US); Roger Norman BATEMAN, Wicklow (IE); Pawel Artur UCHMAN, Dublin (IE); Thomas Gabriel MEIMARIDES, Dublin (IE)

(21) Appl. No.: 17/556,545

(22) Filed: Dec. 20, 2021

Related U.S. Application Data
(60) Provisional application No. 63/273,699, filed on Oct. 29, 2021.

(51) Int. Cl. G06Q 10/10; G06Q 10/06

(52) U.S. Cl. CPC G06Q 10/1095; G06Q 10/063112

(57) ABSTRACT

The present disclosure relates to systems and methods for scheduling meetings for a business process. The systems and methods may dynamically create and send resource requests for meetings based on meeting criteria for the meeting. The systems and methods may identify available resources for a meeting based on attributes of the available resources matching the meeting criteria. The systems and methods may book a meeting with one or more available resources for the meeting.

### CROSS-REFERENCE TO RELATED APPLICATIONS

This application claims priority to and the benefit of U.S. Provisional Pat. Application No. 63/273,699 filed on Oct. 29, 2021, which is hereby incorporated by reference in its entirety.

### BACKGROUND

Business processes may involve multiple individuals. At different phases of the business processes, meetings may be scheduled among different individuals involved in the business process. One example business process that involves multiple individuals is the loan business process. Loan applicants may have several meetings during the loan process with individuals from the bank or financial institution providing the loan. Currently, loan applicants are unable to provide preferences for the meetings (e.g., location, expertise, accessibility, language, and/or ratings for the individuals from the bank that the loan application would like to meet with) when the loan applicants schedule the meetings for the loan. Another example business process is a prescription management process. Patients may schedule meetings with a pharmacist to discuss the prescription during the prescription management process.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method for identifying available resources for a meeting. The method may include receiving a resource request for a meeting for a business process, wherein the resource request includes at least one meeting criteria. The method may include identifying one or more available resources for the meeting based on at least one attribute of the available resources matching the at least one meeting criteria. The method may include sending, in response to the resource request, the one or more available resources for the meeting.

Another example implementation relates to a method for scheduling a meeting. The method may include identifying at least one meeting criteria of a meeting for a business process. The method may include dynamically creating and sending a resource request for the meeting based on the at least one meeting criteria. The method may include presenting one or more available resources for the meeting based on attributes of the one or more available resources matching the at least one meeting criteria. The method may include receiving a selection of an available resource of the one or more available resources and a date and a time for the meeting. The method may include creating a booking for the meeting with the available resource at the date and the time.

Another example implementation relates to a system comprising one or more processors; memory in electronic communication with the one or more processors; and instructions stored in the memory, the instructions being executable by the one or more processors to: receive a resource request for a meeting for a business process, wherein the resource request includes at least one meeting criteria; identify one or more available resources for the meeting based on at least one attribute of the available resources matching the at least one meeting criteria; and send, in response to the resource request, the one or more available resources for the meeting.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for scheduling meetings in accordance with implementations of the present disclosure.

FIG. 2 illustrates example user interface (UI) components for use with a scheduling service in accordance with implementations of the present disclosure.

FIG. 3 illustrates example application programming interfaces (APIs) for use with a scheduling service in accordance with implementations of the present disclosure.

FIG. 4 illustrates an example graphical user interface for scheduling a meeting in accordance with implementations of the present disclosure.

FIG. 5 illustrates an example graphical user interface for presenting available resources for a meeting in accordance with implementations of the present disclosure.

FIG. 6 illustrates an example graphical user interface for presenting a plurality of available resource for a meeting in accordance with implementations of the present disclosure.

FIG. 7 illustrates an example graphical user interface showing additional functionalities available for scheduling a meeting in accordance with implementations of the present disclosure.

FIG. 8 illustrates an example graphical user interface of a meeting confirmation in accordance with implementations of the present disclosure.

FIG. 9 illustrates an example graphical user interface for editing a scheduled meeting in accordance with implementations of the present disclosure.

FIG. 10 illustrates an example graphical user interface for showing a business process and the different meetings associated with the business process in accordance with implementations of the present disclosure.

FIG. 11 illustrates an example method for identifying available resources in accordance with implementations of the present disclosure.

FIG. 12 illustrates an example method for scheduling a meeting in accordance with implementations of the present disclosure.

### DETAILED DESCRIPTION

This disclosure generally relates to scheduling meetings. Business processes may involve multiple individuals, and at different phases of the business processes, meetings may be scheduled among different individuals involved in the business process. An example business process is a loan business process for a loan applicant to receive a loan. Loan applicants may have several meetings during the loan process with individuals from the bank or financial institution providing the loan. Currently, loan applicants are unable to provide preferences for the meetings (e.g., location, expertise, accessibility, language, and/or ratings for the individuals from the bank that the loan application would like to meet with) when the loan applicants schedule the meetings for the loan. Another example business process is an order fulfillment for a retail purchase. A retailer may need to schedule a meeting with customers to discuss the order or any changes or modifications to the order.

The present disclosure provides a personalized booking experience to users (e.g., loan applicants, patients, retail consumers) by providing the users an option to meet individuals of a business process (e.g., loan advisors, doctors, merchants) based on the user’s preferences and choices for the meeting. Example business processes may include, but are not limited to, a healthcare process, a finance process, a retail process, and/or a manufacturing process.

The present disclosure may have a scheduling service that uses preferred meeting criteria to filter bookable resources for the meeting based on the meeting criteria. The preferred meeting criteria may be received from users of the scheduling service. The preferring meeting criteria may include user’s preferences, such as, location of the meeting, languages for the meeting, expertise of individuals, meeting channels, and/or accessibility.

The meeting criteria may also be determined based on previous interactions of the users with the scheduling service. For example, the users’ data, the users’ preferences, associated staff members or individuals that previously met with the users, and/or a booking history of the users may be stored by the scheduling service and used for scheduling subsequent meetings for the users. The meeting criteria may also be automatically determined by the scheduling service using telemetry data, localization data (e.g., location data of the users or the businesses), and/or accessibility data.

The scheduling service may communicate the meeting criteria with a resource engine to identify resources with attributes that match the meeting criteria. The scheduling service may provide an availability table with a view of the matched resources and available dates and times for the matched resources to the scheduler. The scheduling service may compare the calendar information of the users and the matched resources to identify common availability between the users and the matched resources for the meeting. The scheduling service may book the meeting with one or more of the matched resources. As such, the scheduling service provides multi-resource scheduling capabilities so that instead of only scheduling a meeting with a single resource (e.g., one individual), the scheduling service may schedule a meeting with multiple resources (e.g., as many individuals as necessary for the meeting based on the user preferences).

The scheduling service may use one or more machine learning models to intelligently match resources with the meeting criteria. In addition, the scheduling service may use one or more machine learning models to recommend a best resource for the meeting. The recommendation may be based on, for example, learned usage patterns of a user based on previous meetings and/or user profile data (e.g., booking history, associated staff members of a business, meeting preferences).

One technical advantage of some implementations of the present disclosure is faster scheduling of meetings, and thus, reducing time to value. For example, a reduction of the loan processing time from forty five days to thirty days may occur by using the present disclosure. The present disclosure may also reduce the cost per business process, and thereby, reducing total cost of operation of the business process. For example, a reduction of cost per loan from $2500 dollars to $1600 dollars may occur by using the present disclosure. As such, the businesses may use the present disclosure to get more business and provide better user experiences to customers. Moreover, the present disclosure improves collaboration and communication among the individuals involved in the different steps in the business process. The methods and systems may maintain the data privacy of the users of the system. The methods and system may apply different techniques to ensure that the data is used in an abstracted manner so that the data privacy of the users may be maintained.

The present disclosure provides personalized scheduling experiences that may be used across a variety of business processes so that users may use a self-served personalized scheduling service to meet individuals from businesses that match the user preferences. The user preferences may be added and/or modified based on the business process. In a loan application use case, the preferences may include expertise in residential loans and language experience. In a health care use case, the preferences include may include expertise in a specific medical field and covered healthcare plans.

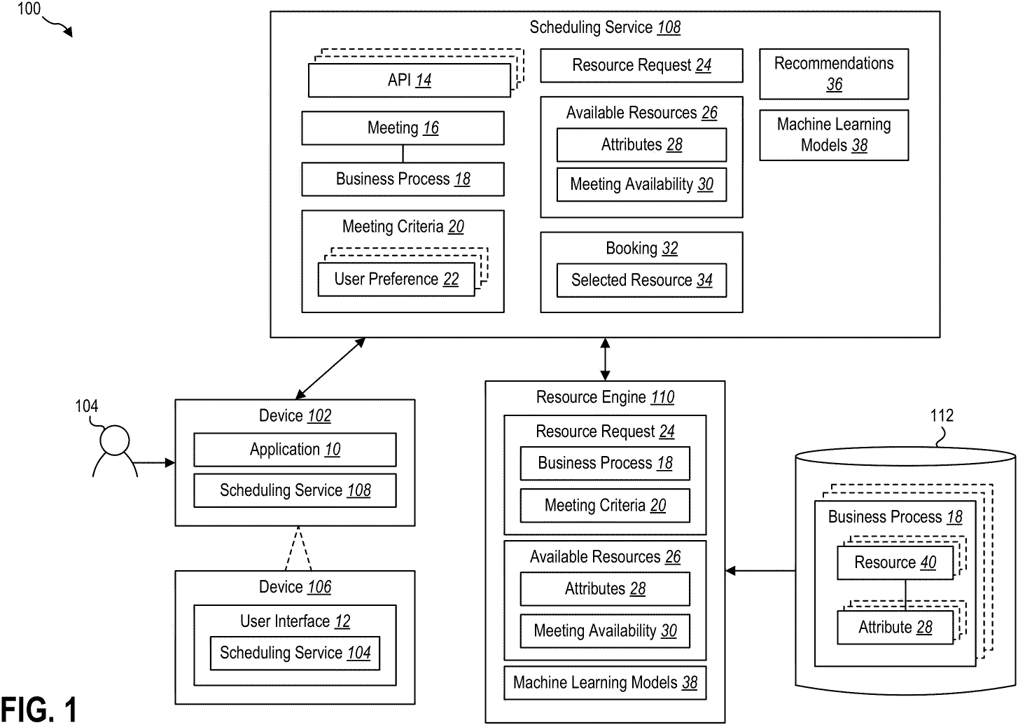

Referring now to FIG. 1, illustrated is an example environment 100 for scheduling meetings. The environment 100 may have a plurality of users 104 interacting with one or more devices 102 to schedule one or more meetings 16 for a business process 18. A business process 18 may include a collection of related, structured activities or tasks by people or equipment in which a specific sequence produces a service or product for a particular customer or customers. One example business process 18 includes loan applications or loan processing for a financial institution. Other example business processes 18 include, but are not limited to, order fulfillment for a retailer, prescription management for a healthcare provider, machine maintenance for a manufacturer, and incident responses for a government agency.

The devices 102 may have applications 10 that the users 104 may use to access a scheduling service 108 for scheduling the meetings 16 for the business process 18. The applications 10 may be specific to a business or may be specific to the business process 18. For example, the user 104 may access an application 10 for a financial institution to schedule a meeting for a loan application. The users 104 may also access the scheduling service 108 through user interface applications on the device 102. In addition, the user 104 may access a portal for the scheduling service 108 using the device 102. For example, the user 104 may access a patient portal and use the scheduling service 108 to schedule a meeting with a doctor.

The scheduling service 108 may have a plurality of application programming interfaces (APIs) 14 that allow the scheduling service 108 the extensibility for use with various applications 10 and/or portals. The APIs 14 provide a reliable, scalable, secure, and cost-effective way of embedding the scheduling service 108 with the different applications 10 and/or portals. As such, any business may use the scheduling service 108 for scheduling meetings 16 for a business process 18 of the business.

The scheduling service 108 may identify one or more meeting criteria 20 for the meeting 16. The meeting criteria 20 may be received from the user 104. For example, the meeting criteria 20 may include user preferences 22 received from the user 104. Examples of the user preferences 22 include, but are not limited to, a location of the meeting, a meeting channel, expertise of an individual, knowledge of an individual, capabilities of an individual, specialties of an individual, a preferred language for the meeting, a time range for the meeting (dates for the meeting or times for the meeting), and/or any other preferences used in the business process. The meeting criteria 20 may be dynamic in nature and may change for different businesses or business processes 18.

In addition, the meeting criteria 20 may be automatically determined. The scheduling service 108 may automatically determine the meeting criteria 20 based on user profile information or previous information received from the user 104 for past meetings 16 that the user 104 scheduled using the scheduling service 108. The scheduling service 108 may also automatically determine the meeting criteria 20 based on the business process 18. For example, a loan applicant may need to have an initial meeting with the lending institution within a certain number of days from applying for the loan. As such, the scheduling service 108 may automatically determine a date range for the meeting 16 as a meeting criteria 20 for the meeting 16. The scheduling service 108 may use telemetry data, localization data, and/or accessibility data in automatically determining the meeting criteria 20.

The scheduling service 108 may dynamically create a resource request 24 for a meeting 16 for the business process 18 based on the meeting criteria 20. The scheduling service 108 may communicate with a resource engine 110 to identify available resources 26 (e.g., available individuals of the business) for the meeting 16 based on the meeting criteria 20. The resources 26 may be employees of a company (e.g., loan officers in a bank or doctors in a hospital). The scheduling service 108 defines the resource requirements for the meeting 16 based on the meeting criteria 20 without having to statically define the resource requirements for the meetings 16 prior to creating the resource request 24.

The resource engine 110 may access a datastore 112 with the plurality of resources 40 for the business process 18. Each resource of the plurality of resources 40 may be associated with one or more attributes 28. The attributes 28 may identify skills, experiences, capabilities, specialties, domain knowledge, or other information about the resource (e.g., the different individuals of the business). In an implementation, the datastore 112 is a system of record that stores information about the business process 18.

The resource engine 110 may analyze the received resources 40 and associated attributes 28 to determine whether any of the attributes 28 match the meeting criteria 20. The resource engine 110 may identify the resource 40 as an available resource 26 for the meeting 16 based on a match occurring between the attributes 28 of the resource 40 and the meeting criteria 20. For example, if the meeting criteria 20 included an individual that specializes in residential loans and speaks Spanish, the resource engine 110 may identify all resources 40 with attributes 28 of residential loans specialties and having Spanish language capabilities as an available resource 26. As such, the resource engine 110 may identify the available resources 26 for the meeting by intelligently matching the attributes 28 associated with the available resources 26 to the meeting criteria 20. In some implementations, based on the user preferences 22 provided, custom action APIs intelligently locate the employees (e.g., the available resources 26) that match the user preferences 22. Once identified, the employees (e.g., the available resources 26) are used to create an appointment for the meeting 16.

The resource engine 110 may further determine a meeting availability 30 for each of the available resources 26 to determine any dates or times the available resources 26 may be available for the meeting 16. The resource engine 110 may obtain calendar information for each of the available resources 26 to identify available dates or times for the meeting 16.

The resource engine 110 may rank the available resources 26 to place the available resources 26 in an order, where a highest ranked resource is a most eligible available resource relative to the remaining available resources. The ranking may be based on a number of attributes 28 of the available resource 26 matching the meeting criteria 20 (e.g., the available resources 26 with more attributes 28 matching the meeting criteria 20 have a higher ranking relative to the available resources 26 with less attributes 28 matching). The ranking may also be based on a previous meeting with the user 104. For example, if the available resource 26 previously meet with the user 104, the available resource 26 may have a higher rank relative to other available resources 26 without a previous association to the user 104.

The resource engine 110 may include one or more machine learning models 38 to determine the available resources 26. The machine learning models 38 may be domain agnostic or may be optimized to be domain specific. The machine learning models 38 may learn usage patterns of the user 104 based on previous meetings of the user 104 and/or user profile data (booking history, associated staff members of a business, meeting preferences) and/or to learn user behaviors of the user 104. In some implementations, the previous engagements, meetings, and/or the information obtained from the previous engagements and meetings (e.g., booking history, meeting preferences, etc.) serve as the dataset that the machine learning models 38 use to find and recommend the available resources 26 (e.g., an employee that matches the attributes identified from the dataset). One example of the machine learning model 38 includes a regression model. In addition, the dataset may be used as training input to train the machine learning models 38. As such, the machine learning models 38 learn the usage patterns of the user 104 using the information obtained from the previous engagements and/or meetings of the user 104. The resource engine 110 may use the learned usage patterns of the user 104 to determine the available resources 26 for the meeting 16.

The scheduling service 108 may also have one or more machine learning models 38 that make recommendations 36 for a best resource (e.g., one resources of the available resources 26) based on the collected data of the user 104 and/or the learned usage patterns of the user 104. For example, after the user 104 makes an initial appointment or meeting 16 providing the user preferences 22 for the meeting 16, the machine learning models 38 may use the information provided by the user 104 and/or any interactions of the user 104 with the scheduling service 108 to make recommendations 36 for a best resource of the available resources 26 for the meeting 16.

The scheduling service 108 may present the available resources 26 to the user 104, for example, on a user interface 12 on a display 106 of the device 102. The scheduling service 108 may provide an availability table with a view of the matched available resources 26 and the meeting availability 30. The meeting availability 30 may show available dates and times for the available resources 26. The scheduling service 108 may compare the calendar information of the user 104 and the available resources 26 to identify common meeting availability 30 between the user’s 104 calendar and the available resources’ 26 calendars.

The scheduling service 108 may receive a selected resource 34 of the available resource 34 and a selected date and time for the meeting 16. The selected resource 34 may be the available resource 26 recommended by the resource engine 110 as the best available resource for the meeting 16. In addition, the selected resource 34 may be a highest ranked available resource 26 for the meeting 16.

In an implementation, the user 104 may select a plurality of available resources 26 as the selected resource 34. For example, if the user 104 wants to meet with two individuals (e.g., a loan officer and a financial advisor), the user 104 may select two different available resources 26 as the selected resource 34. Any number of available resources 26 may be added to the meeting 16 based on the meeting criteria 20.

The scheduling service 108 creates a booking 32 for the meeting 16 with the selected resource 34 at the selected date and time. The scheduling service 108 may automatically place the booking 32 for the meeting 16 on a calendar of the user 104 and the selected resource 34. In addition, the scheduling service 108 may allow the user 104 to update or cancel the booking 32. The scheduling service 108 may also provide feature enhancements, such as, text message reminders for the meeting 16, confirmation of the booking 32, and/or attachment links to the meeting 16 so that the user 104 may upload documents or other files to the meeting invite.

The scheduling service 108 ties the booking 32 for the meeting 16 to the business process 18 so that any individual involved in the business process 18 (e.g., the user 104, available resources 26, other employees of the business) may view the different bookings 32 and/or meetings 16 for the business process 18 and have a single view of the entire business process 18. The scheduling service 108 may improve collaboration and communications around the different steps or tasks of the business process 18 by providing a single view of the business process 18 to all the individuals involved in the business process 18.

The environment 100 may have multiple machine learning models (e.g., machine learning models 38) running simultaneously. In some implementations, one or more computing devices are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the scheduling service 108, the resource engine 110, and/or the datastores 112 are implemented wholly on the same computing device. Another example includes one or more subcomponents of the scheduling service 108, the resource engine 110, and/or the datastores 112 implemented across multiple computing devices. Moreover, in some implementations, the scheduling service 108, the resource engine 110, and/or the datastores 112 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, the environment 100 may be used provide personalized scheduling experiences across a variety of business processes 18 so that users 104 may use a self-served personalized scheduling service 108 to meet individuals (e.g., the available resources 26) from businesses that match the user preferences 22 for the meetings 16.

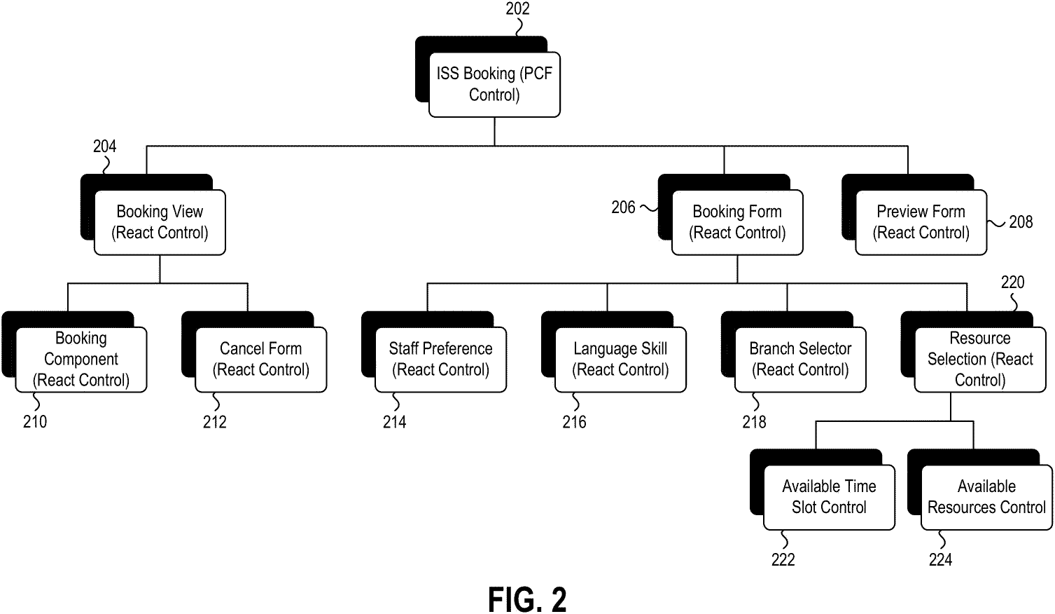

Referring now to FIG. 2, illustrated are example user interface (UI) components 202, 204, 206, 208, 210, 212, 214, 216, 218, 220, 222, 224 for use with the scheduling service 108 (FIG. 1). The user interface components 202, 204, 206, 208, 210, 212, 214, 216, 218, 220, 222, 224 may be presented on the user interface 12 of the display 106 to provide the user 104 access to the scheduling service 108. In addition, the user interface components 202, 204, 206, 208, 210, 212, 214, 216, 218, 220, 222, 224 are fully accessible by the users 104.

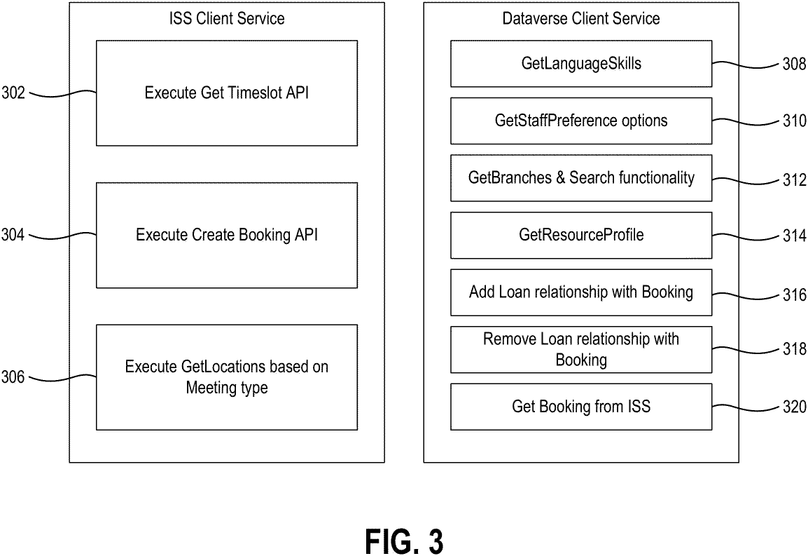

Referring now to FIG. 3, illustrated are example application programming interfaces (APIs) 302, 304, 306 for use with the scheduling service 108. The APIs 302, 304, 306, may be consumed by front end controls to view or create a booking. The APIs 302, 304, 306 may provide a reliable, scalable, secure, and cost-effective way of embedding the scheduling service 108 with different applications and/or portals for different business processes 18 (FIG. 1). The APIs 302, 304, 306 may be used by the scheduling service 108 to schedule the different meetings 16 (FIG. 1). FIG. 3 also illustrates additional features 308, 310, 312, 314, 316, 318, 320 that the scheduling service 108 may use in scheduling the meetings 16 and/or updating or revising the meetings 16.

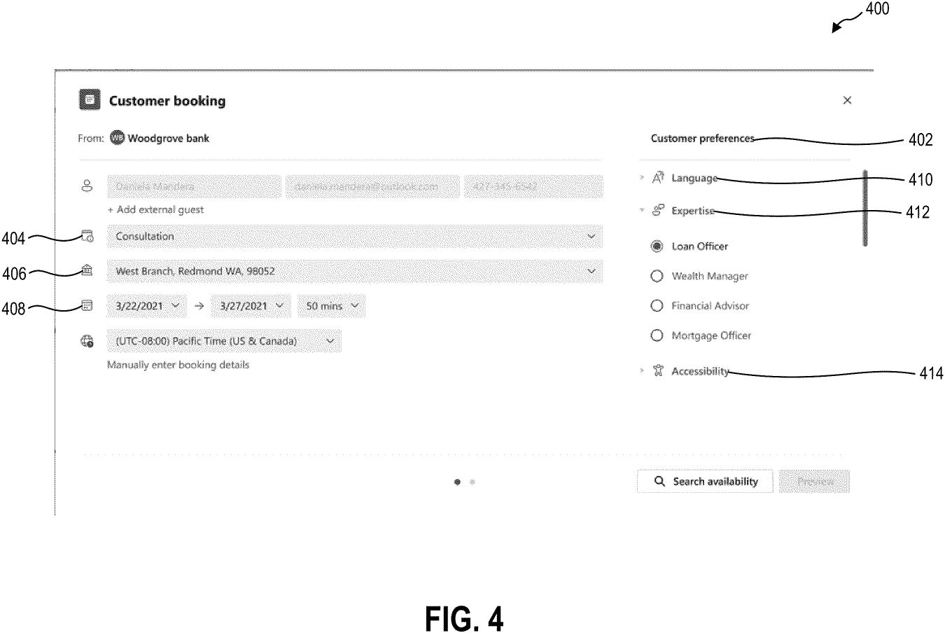

Referring now to FIG. 4, illustrated is an example graphical user interface (GUI) 400 for scheduling a meeting 16 (FIG. 1) using the scheduling service 108 (FIG. 1). The GUI 400 may include inputs for a plurality of user preferences 402, such as, a meeting type 404, a meeting location 406, a meeting date range 408, a language for the meeting 410, an expertise of an individual 412, and meeting accessibility 414. The scheduling service 108 may automatically fill in the user preferences 402 based on the user profile data or previous interactions of the user 104 (FIG. 1) with the scheduling service 108.

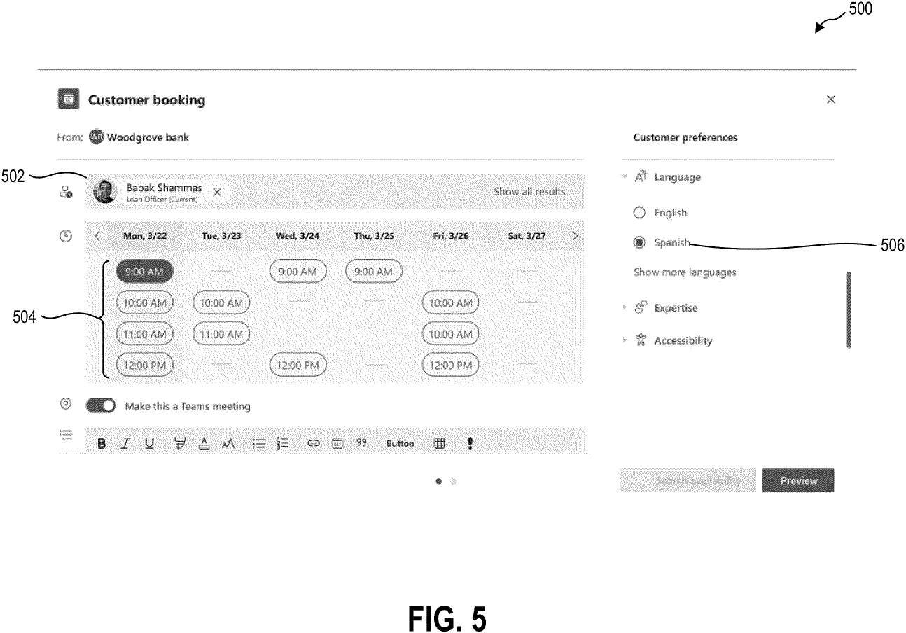

Referring now to FIG. 5, illustrated is an example GUI 500 for presenting available resources for a meeting 16 (FIG. 1). The GUI 500 may present an available resource 502 (e.g., an available loan officer) that the scheduling service 108 (FIG. 1) determined matches one or more of the user preferences for a meeting 16. The GUI 500 may indicate which user preferences that the available resource 502 matches (e.g., the Spanish language preference 506). In addition, the GUI 500 may present an availability table 504 with the available dates and times for the meeting 16. The availability table 504 may be based on the calendar information of the user 104 scheduling the meeting 16 and/or the calendar information of the available resource 502. As such, the availability table 504 may present common times available in the schedules of the user 104 and the available resource 502 for the meeting 16.

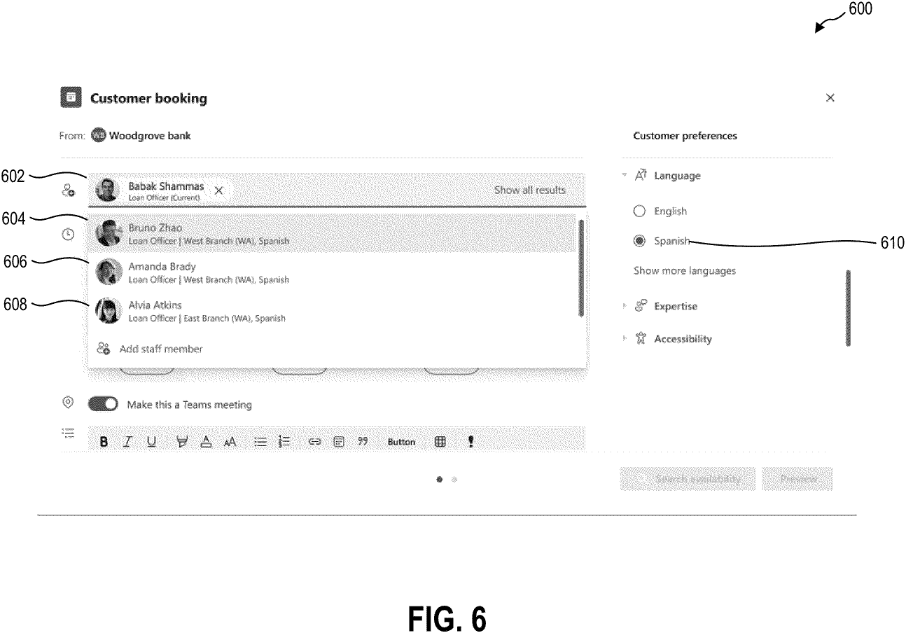

Referring now to FIG. 6, illustrated is an example GUI 600 for presenting a plurality of available resources for a meeting 16 (FIG. 1). The GUI 600 may present a plurality of available resources 602, 604, 606, 608 (e.g., multiple loan officers) that the scheduling service 108 (FIG. 1) determined matches one or more of the user preferences for a meeting 16. The GUI 600 may indicate which user preferences that the available resources 602, 604, 606, 608 matched (e.g., the Spanish language preference 610). The scheduling service 108 may rank the available resources 602, 604, 606, 608 and may present the available resources 602, 604, 606, 608 in an order based on the ranking with a highest ranked resource (e.g., the available resource 602) presented first. The ranking may be based on past interactions with the user 104. For example, if the available resource 602 previously met with the user 104, the available resource 602 may have the highest ranking compared to the other available resources 604, 606, 608. The ranking may also be based on a location of the available resources. For example, if the available resource 608 is located a different location (e.g., the East Branch) than the other available resources 602, 604, 606 located at the West Branch, the available resource 608 may receive a lower ranking relative to the other available resources 602, 604, 606.

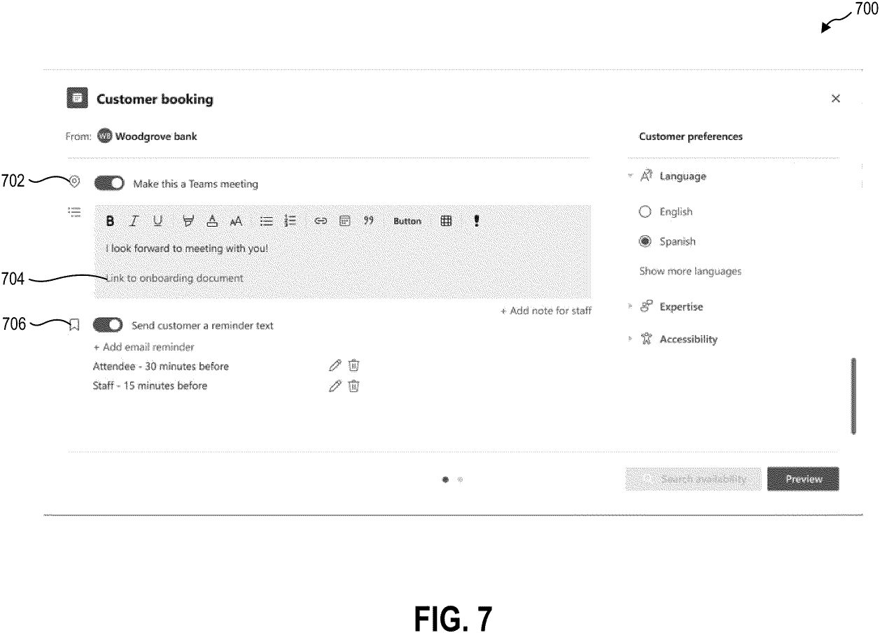

Referring now to FIG. 7, illustrated is an example GUI 700 showing additional functionalities available for scheduling a meeting 16 (FIG. 1). The additional functionalities may include selecting a meeting channel 702 for the meeting 16, linking additional documents or files 704 to the meeting invite, and/or sending reminder messages 706 (e.g., text messages or e-mail messages) for the meeting 16.

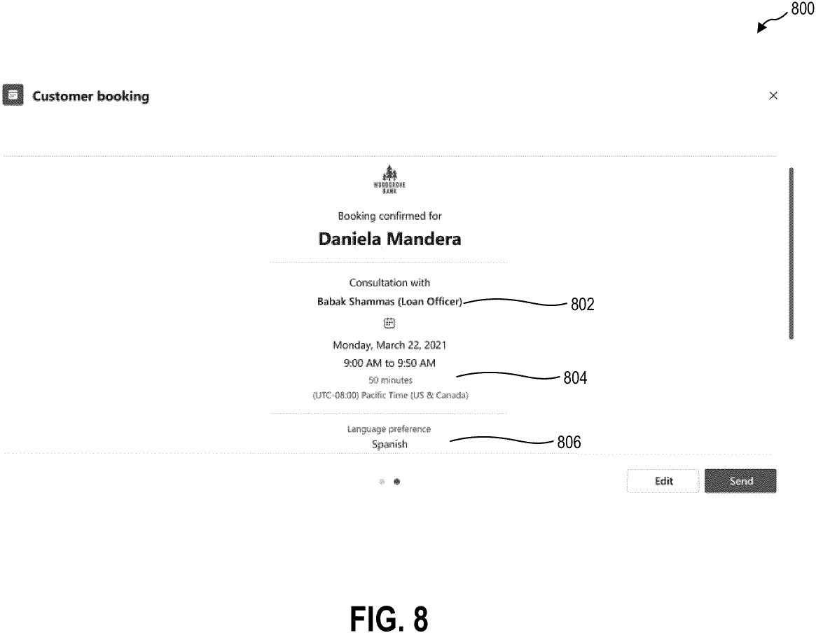

Referring now to FIG. 8, illustrated is an example GUI 800 of a meeting confirmation generated by the scheduling service 108 (FIG. 1) to confirm a booking 32 (FIG. 1) of a meeting 16 (FIG. 1). The GUI 800 may identify the selected resource 802 for the meeting 16, the selected date and time 804 for the meeting 16, and the user preferences 806 for the meeting 16. The scheduling service 108 may send the booking 32 to the selected resource 802 upon receiving a confirmation of the user 104 for the booking 32 (e.g., the user 104 selecting the send icon).

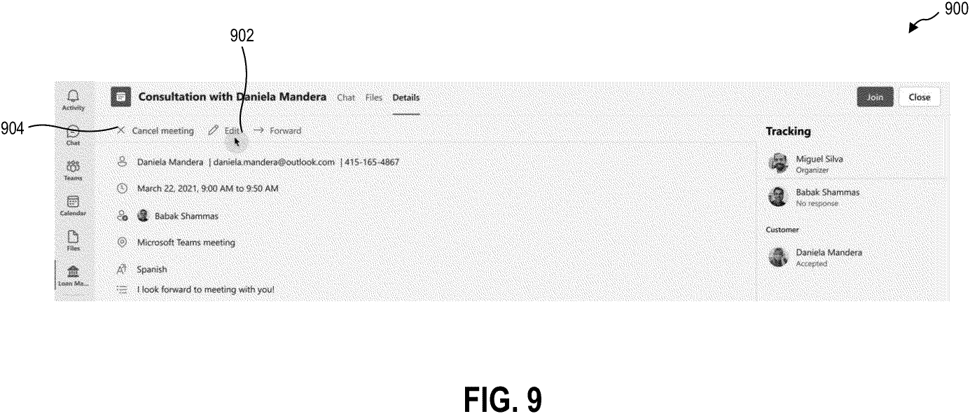

Referring now to FIG. 9, illustrated is an example GUI 900 for editing a scheduled meeting 16 (FIG. 1). The GUI 900 may have an edit icon 902 or a cancel meeting icon 904 that the user 104 may select to make changes to a scheduled meeting 16 or cancel a scheduled meeting 16. The scheduling service 108 provides the user 104 with flexibility in modifying or changing scheduled meetings 16.

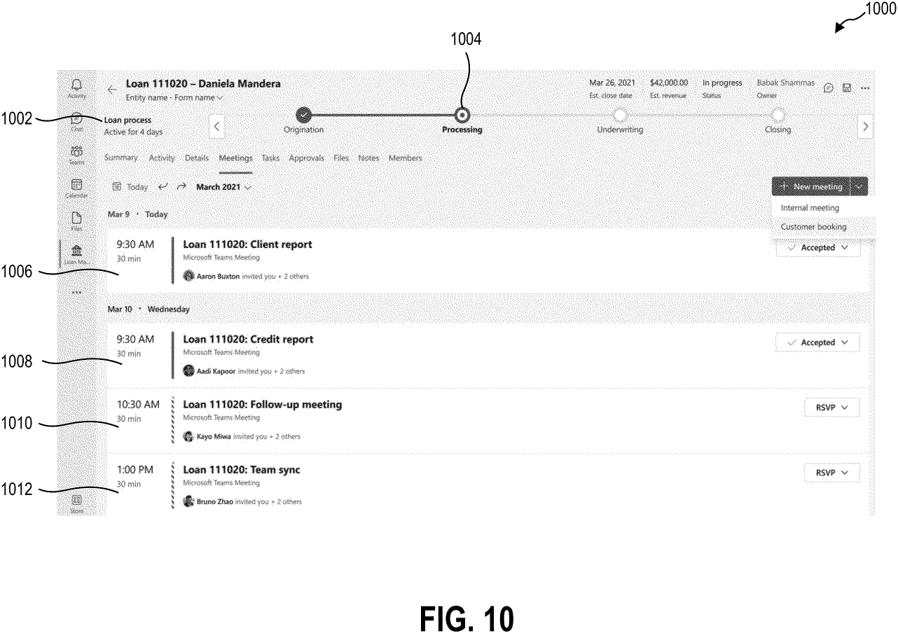

Referring now to FIG. 10, illustrated is an example GUI 1000 for showing a business process (e.g., the loan process 1002) and the different meetings 1006, 1008, 1010, 1012 associated with the business process. The GUI 1000 may identify at what step the user 104 currently is at in the business process (e.g., processing 1004). The GUI 1000 may be used by any individual involved in the loan process 1002 to have a single view of the business process and easily identify the meetings 1006, 1008, 1010, 1012 scheduled for the business process (e.g., the loan process 1002) or easily identify which meetings have already occurred for the business process. As such, the GUI 1000 may provide a centralized record of the business process and may improve collaboration and communication around the different steps involved in the business process.

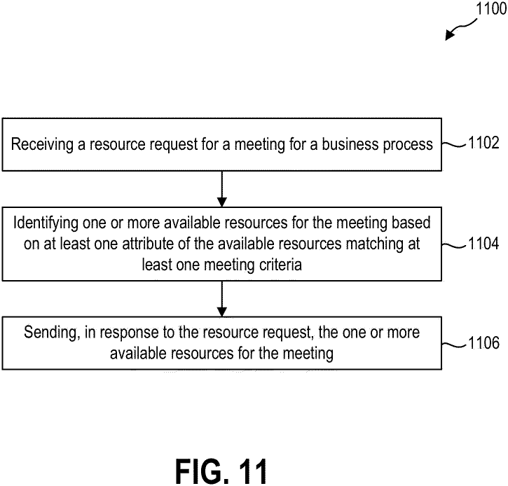

Referring now to FIG. 11, illustrated is an example method 1100 for identifying available resources for a meeting. The actions of the method 1100 are discussed below with reference to the architecture of FIG. 1.

At 1102, the method 1100 includes receiving a resource request for a meeting for a business process. The resource engine 110 may receive a resource request 24 for a meeting 16 for a business process 18. The resource request 24 may also identify one or more meeting criteria 20 for the meeting 16. In some implementations, the meeting criteria 20 is a user preference for the meeting 16. Example user preferences for the meeting 16 include, but are not limited to, a location for the meeting, a date range for the meeting, a time range for the meeting, a language for the meeting, an expertise of an individual for the meeting, or any other preferences used in the business process.

At 1104, the method 1100 includes identifying one or more available resources for the meeting based on the at least one attribute of the available resources matching at least one meeting criteria. The resource engine 110 may identify one or more available resources 26 based on the attributes 28 of the available resources 26 matching the meeting criteria 20. In some implementations, one or more machine learning models 38 identify the available resources 26 for the meeting 16.

In some implementations, the available resources 26 include individuals and the attributes 28 includes a capability or a specialty of the individuals. One example use case includes the business process 18 is a loan application and the available resources 26 are financial advisors for the loan application. Another example use case includes the business process 18 is a healthcare process and the available resources 26 are healthcare providers or pharmacist for the healthcare process. Another example use case includes the business process 18 is a finance process and the available resources 26 are financial advisors for the finance process. Another example use case includes the business process 18 is a retail process and the available resources 26 are employees for the retail company. Another example use case includes the business process is a manufacturing process and the available resources 26 are the employees for the manufacturing company.

In some implementations, the scheduling service 108 may also have one or more machine learning models 38 that make recommendations 36 for a best resource (e.g., one resources of the available resources 26) based on the collected data of the user 104 and/or the learned usage patterns of the user 104. The scheduling service 108 provides a machine learning algorithm based recommendation 36 of the available resources 26 for the meeting 16. In some implementations, the scheduling service 108 ranks the available resources 26 and provides the recommendation 36 for a highest ranked resource. In some implementations, the scheduling service 108 provides the recommendation 36 based on one or more of learned usage patterns of the user 104 or user profile information.

At 1106, the method 1100 includes sending, in response to the resource request, the one or more available resources for the meeting. The resource engine 110 may send the available resources 26 for the meeting 16 to the scheduling service 108. In some implementations, the resource engine 110 obtains calendar information for the one or more available resources 26; identifies the meeting availability 30 with dates and times for the meeting 16 based on the calendar information; and presents the meeting availability 30 for the meeting 16.

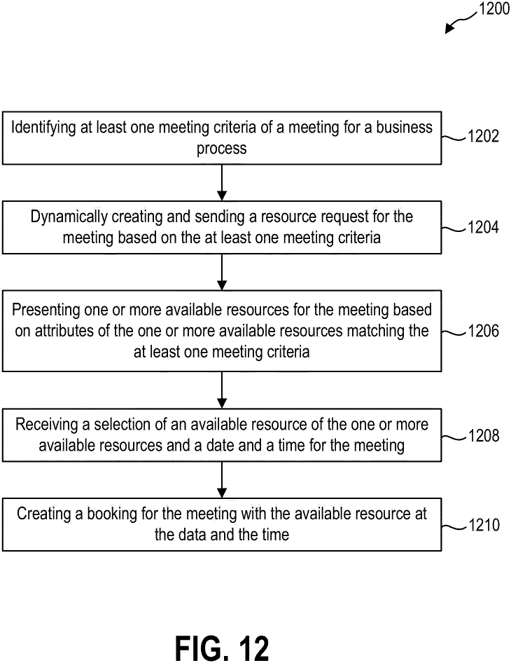

Referring now to FIG. 12, illustrated is an example method 1200 for scheduling a meeting. The actions of the method 1200 are discussed below with reference to the architecture of FIG. 1.

At 1202, the method 1200 includes identifying at least one meeting criteria of a meeting for a business process. The scheduling service 108 may identify meeting criteria 20 of a meeting 16 for a business process 18. The meeting criteria 20 may include user preferences 22 for the meeting 16. In some implementations, the scheduling service 108 automatically identifies the meeting criteria 20 based on a usage patterns of a user, user data, and/or user profile information. In some implementations, the scheduling service 108 receives the meeting criteria 20 from the user 104 for the meeting 16. In some implementations, the scheduling services 108 uses one or more machine learning models 38 to identify the meeting criteria 20.

At 1204, the method 1200 includes dynamically creating and sending a resource request for the meeting based on the at least one meeting criteria. The scheduling service 108 may dynamically create and send a resource request 24 based on the meeting criteria 20 to the resource engine 110.

At 1206, the method 1200 includes presenting one or more available resources for the meeting based on attributes of the one or more available resources matching the at least one meeting criteria. The scheduling service 108 may receive from the resource engine 110 available resources 26 for the meeting 16 that match the meeting criteria 20. In some implementations, the available resources 26 include individuals and the attributes 28 include a capability or a specialty of the individuals. The scheduling service 108 may present the attributes 28 of the available resources 26 and the available dates and times for the meeting 16.

At 1208, the method 1200 includes receiving a selection of an available resource of the one or more available resources and a date and a time for the meeting. The scheduling service 108 may receive a selection of the available resource 26 (e.g., the selected resource 34) and a selection of a date and time for the meeting 16 from the user 104.

At 1210, the method 1200 includes creating a booking for the meeting with the available resource at the date and the time. The scheduling service 108 may create a booking 32 for the meeting 16 with the selected resource 34 at the date and time. In some implementations, the scheduling service 108 automatically places the booking 32 for the meeting 16 on a calendar of the available resource 26 in response to creating the booking 32 for the meeting 16. In some implementations, the scheduling service 108 receives a selection of two available resources of the available resources 26 and a date and a time for the meeting, and the scheduling service 108 creates the booking 32 for the meeting 16 with the two available resources at the date and the time.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for identifying available resources for a meeting, comprising:
receiving a resource request for a meeting for a business process, wherein the resource request includes at least one meeting criteria;
identifying one or more available resources for the meeting based on at least one attribute of the available resources matching the at least one meeting criteria; and
sending, in response to the resource request, the one or more available resources for the meeting.

2. The method of claim 1, wherein the at least one meeting criteria is a user preference for the meeting.

3. The method of claim 2, wherein the user preference is one or more of a location for the meeting, a date range for the meeting, a time range for the meeting, a language for the meeting, an expertise of an individual for the meeting, or any other preferences used in the business process.

4. The method of claim 1, wherein the one or more available resources include individuals and the at least one attribute includes a capability or a specialty of the individuals.

5. The method of claim 4, wherein the business process is a loan application, and the one or more available resources are financial advisors for the loan application.

6. The method of claim 1, wherein the business process is one or more of a healthcare process, a finance process, a retail process, or a manufacturing process.

7. The method of claim 1, further comprising:
obtaining calendar information for the one or more available resources;
identifying meeting availability with dates and times for the meeting based on the calendar information; and
presenting the meeting availability for the meeting.

8. The method of claim 1, further comprising:
providing a machine learning algorithm based recommendation of one available resource for the meeting.

9. The method of claim 8, wherein the recommendation is based on one or more of learned usage patterns of a user or user profile information.

10. The method of claim 8, further comprising:
ranking the one or more available resources, and
wherein the recommendation is for a highest ranked resource.

11. The method of claim 1, wherein one or more machine learning models identify the available resources for the meeting.

12. A method for scheduling a meeting, comprising:
identifying at least one meeting criteria of a meeting for a business process;
dynamically creating and sending a resource request for the meeting based on the at least one meeting criteria;
presenting one or more available resources for the meeting based on attributes of the one or more available resources matching the at least one meeting criteria;
receiving a selection of an available resource of the one or more available resources and a date and a time for the meeting; and
creating a booking for the meeting with the available resource at the date and the time.

13. The method of claim 12, wherein the one or more available resources include individuals, and the attributes include a capability or a specialty of the individuals.

14. The method of claim 12, wherein presenting the one or more available resources further includes presenting the attributes of the one or more available resources and available dates and times for the meeting.

15. The method of claim 12, wherein the at least one meeting criteria is a user preference received from a user for the meeting.

16. The method of claim 12, wherein the method includes:
automatically identifying the at least one meeting criteria based on one or more of usage patterns of a user, user data, or user profile information.

17. The method of claim 12, wherein creating the booking of the meeting automatically places the booking for the meeting on a calendar of the available resource.

18. The method of claim 12, further comprising:
receiving a selection of two available resources of the one or more available resources and a date and a time for the meeting; and
creating a booking for the meeting with the two available resources at the date and the time.

19. The method of claim 12, wherein one or more machine learning models identify the least one meeting criteria.

20. A system, comprising:
one or more processors;
memory in electronic communication with the one or more processors; and
instructions stored in the memory, the instructions being executable by the one or more processors to:
receive a resource request for a meeting for a business process, wherein the resource request includes at least one meeting criteria;
identify one or more available resources for the meeting based on at least one attribute of the available resources matching the at least one meeting criteria; and
send, in response to the resource request, the one or more available resources for the meeting.
